(19) United States
(12) Patent Application Publication
(10) Pub. No.: US 2006/0265236 A1
(43) Pub. Date: Nov. 23, 2006

(54) Method and apparatus for communicating product notices through digital broadcasting

(76) Inventors: Jack Ivan J'maev, Chino, CA (US); Addison Brooke Jones, Yorba Linda, CA (US); Tzvetelin Petrov Petrov, Chino, CA (US)

Correspondence Address: INTELLECTUAL PROPERTY DEVELOPMENT;JACK IVAN J'MAEV, 14175 TELEPHONE AVE., SUITE L, CHINO, CA, 91710, US

(21) Appl. No.: 11/371,366

(22) Filed: Mar. 7, 2006

Related U.S. Application Data
(63) Continuation-in-part of application No. 10/615,412, filed on Jul. 7, 2003.
(60) Provisional application No. 60/394,980, filed on Jul. 9, 2002.
(60) Provisional application No. 60/660,509, filed on Mar. 8, 2005.

(51) Int. Cl. G06Q 99/00

(52) U.S. Cl. 705/1

(57) ABSTRACT

Disclosed are a method and several embodiments for issuing and receiving a product notice message by incorporating a product notice message into at least one of a control data stream and a program data stream carried in digital broadcast data stream. This is accomplished by combining at least one of a control data stream and a program data stream into a time-multiplexed data stream, splintering the multiplexed data stream into a plurality of sub-streams, generating a corresponding plurality of modulated carriers according to each of the sub-streams, combining the plurality of modulated carriers into a composite radio frequency signal and then radiating the composite radio frequency signal. In order to receive the signal, the composite radio frequency signal that includes a plurality of modulated carriers is received and each carrier therein is demodulated into a plurality of corresponding data sub-stream. These are then combined into a time-multiplexed, multi-channel data stream. A channel is these selected from at least one of the control channel and the program channel which are typically included in the time-multiplexed, multi-channel data stream. A product notice is extracted from the selected channel and presented to a user.

### RELATED APPLICATIONS

The present application is a continuation-in-part of still pending U.S. patent application Ser. No. 10/615,412 entitled “Method and Apparatus for Receiving Product Notices” by J'maev filed on Jul. 7, 2003, which itself claimed priority to U.S. Provisional Application No. 60/394,980 filed on Jul. 9, 2002, entitled “Method and Apparatus for Product Recall”, by J'maev; the present application also claims priority to U.S. Provisional Application No. 60/660,509 filed on Mar. 8, 2005 entitled “Method and Apparatus for Communicating Product Notices Through Digital Broadcasting” by J'maev et al.

### BACKGROUND

Numerous modalities have been contemplated for conveying recall and other product notice messages to products. One problem with all of the conveyance modalities contemplated thus far is that of bandwidth. In most classes of products, the amount of bandwidth necessary to convey product recall notices and product maintenance notices is very modest. For example, a data rate of only a few bits per second can be sufficient to service most recall messages for many of the products sold in the United States.

There are, however, many different products that are recalled with very frequently. Other classes of products are called in for maintenance on a regular basis. In order to service these types of products, a high aggregate data rate is required. In order to service these types of products, a higher bandwidth delivery system is required. The problem with a high bandwidth delivery system is cost. The cost to deploy a high bandwidth transmission system for product notices would be highly undesirable. Even more challenging is the need to provide a low-cost receiver for receiving recall and other product notice data from such a high-bandwidth transmission system.

### SUMMARY

Disclosed are a method and several embodiments for issuing and receiving a product notice message by incorporating a product notice message into at least one of a control data stream and a program data stream carried in digital broadcast data stream. This is accomplished by combining at least one of a control data stream and a program data stream into a time-multiplexed data stream, splintering the multiplexed data stream into a plurality of sub-streams, generating a corresponding plurality of modulated carriers according to each of the sub-streams, combining the plurality of modulated carriers into a composite radio frequency signal and then radiating the composite radio frequency signal. In order to receive the signal, the composite radio frequency signal that includes a plurality of modulated carriers is received and each carrier therein is demodulated into a plurality of corresponding data sub-stream. These are then combined into a time-multiplexed, multi-channel data stream. A channel is these selected from at least one of the control channel and the program channel which are typically included in the time-multiplexed, multi-channel data stream. A product notice is extracted from the selected channel and presented to a user.

### BRIEF DESCRIPTION OF THE DRAWINGS

Several alternative embodiments will hereinafter be described in conjunction with the appended drawings and Fig.s, wherein like numerals denote like elements, and in which:

FIG. 1 is pictorial diagram that depicts a system for conveying a product notice to a product using a digital broadcast channel;

FIGS. 2 and 3 comprises a flow diagram that depicts alternative example methods for conveying a product notice message to a product notice receiver;

FIG. 4A is a flow diagram that depicts one example method for receiving a product notice message according to a product identifier;

FIG. 4B is a pictorial diagram that illustrates one example embodiment of a product notice message that includes a product identifier;

FIG. 5A is a flow diagram that depicts one alternative example method for receiving a product notice message according to a receiver identifier;

FIG. 5B is a pictorial illustration that depicts one example embodiment of a product notice message that includes a receiver identifier;

FIG. 6A is a flow diagram that depicts one variation of the present method for receiving a product notice message that includes both the receiver identifier and a product identifier;

FIG. 6B is a pictorial diagram that depicts one alternative example embodiment of a product notice message that includes both a receiver identifier and product identifier;

FIG. 7 is a flow diagram that depicts one alternative example method for generating a plurality of carriers;

FIG. 8 is a flow diagram that depicts one alternative example method for generating a plurality of carriers;

FIG. 9 is a flow diagram that depicts example alternative methods for receiving a product notice message;

FIG. 10 is a flow diagram that depicts one alternative example method for extracting a product notice message according to a product identifier;

FIG. 11 is a flow diagram that depicts one alternative method for extracting a product notice message according to a receiver identifier;

FIG. 12 is a flow diagram that depicts one example alternative method for demodulating a plurality of carriers;

FIG. 13 is a flow diagram that depicts yet another example method for demodulating a plurality of carriers;

FIG. 14 is a flow diagram that depicts an alternative method for receiving a product notice;

FIG. 15 is a flow diagram that depicts yet another alternative example method for receiving a product notice message;

FIG. 16 is a block diagram that depicts several alternative example embodiments of a product notice transmitter;

FIG. 17 is a block diagram that depicts several alternative example embodiments of a digital signal processing multi-carrier modulator;

FIG. 18 is a dataflow diagram that it beats the internal operation of several alternative example embodiments of a digital signal processing based multi-carrier modulator;

FIG. 19 is a pictorial representation that depicts several alternative example embodiments of the time-multiplexed datastream;

FIG. 20 is a block diagram that depicts several example alternative embodiments of the product notice receiver;

FIG. 21 is a block diagram that depicts one alternative example embodiment of a discrete multi-carrier demodulator;

FIG. 22 is a block diagram depicts one alternative example embodiment of a signal processing based multi-carrier demodulator;

FIG. 23 is a dataflow diagram that depicts the internal operation of several example alternative embodiments of a digital signal processing based multi-carrier demodulated; and

FIG. 24 is a block diagram that depicts one alternative example embodiment of a message framer capable of capturing a product notice message according to a product identifier.

### DETAILED DESCRIPTION

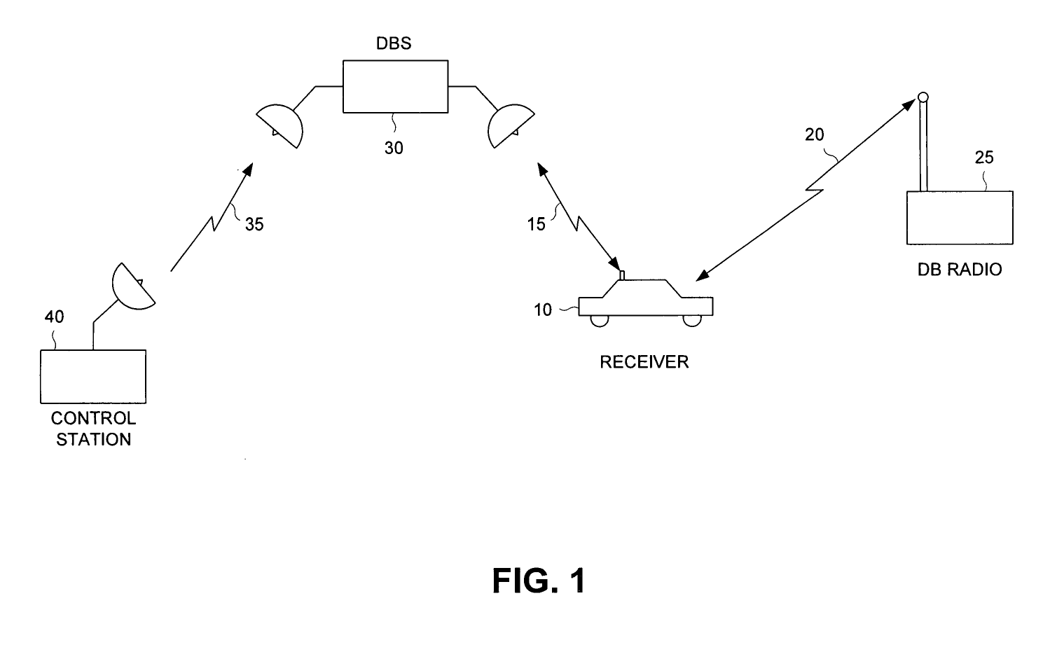

U.S. patent application Ser. No. 10/615,345 entitled “Method and Apparatus for Receiving Product Notices” by J'maev filed on Jul. 7, 2003 is hereby incorporated into this application in its entirety. As described in this referenced application, Applicant has described a method and apparatus for disseminating product notices and receiving these notices in a product by means of a receiver that is integrated into the product. As such, various embodiments have been contemplated by Applicant for disseminating information to a receiver integrated into a product. As depicted in the FIG. 1, yet another example method for issuing a product notice message to a product noticed receiver, in which the receiver is integrated into a product, comprises issuing a product notice from a control station 40 to a receiver 10 integrated in the product. In one example variation, the control station uses an uplink 35 in order to direct a product notice message to a direct broadcast satellite 30 (DBS). The direct broadcast satellite 30 then propagates 15 the product notice message to the receiver 10. In an alternative illustrative use case, the present method is utilized with a direct broadcast radio station 25. In this situation, the direct broadcast radio station 25 conveys 20 the product notice message directly to the receiver 10. It should be appreciated that these two illustrative use cases are presented herein merely to illustrate various example methods and embodiments of an apparatus for conveying a product notice message to a product noticed receiver 10. It should likewise be appreciated that the signaling means used in the control-station-to-direct-broadcast-satellite path and the signaling means used in the direct-broadcast-radio path rely on digital broadcast radio technology. It should be appreciated that a product notice includes a notice that relates to the condition of the product in which it is received, including, but not limited to a recall notice, a product upgrade notice, a product calibration notice, a product end-of-life notice, a product maintenance notice. It should be appreciated that these example notice types are presented herein merely to illustrate the usage of the present method and are not intended to limit the scope of the claims appended hereto. Commensurate with the teachings of the incorporated reference, a product notice, according to one alternative method, is augmented with a product notice identifier that is correlated with a description of the notice, said description being stored in a distal memory.

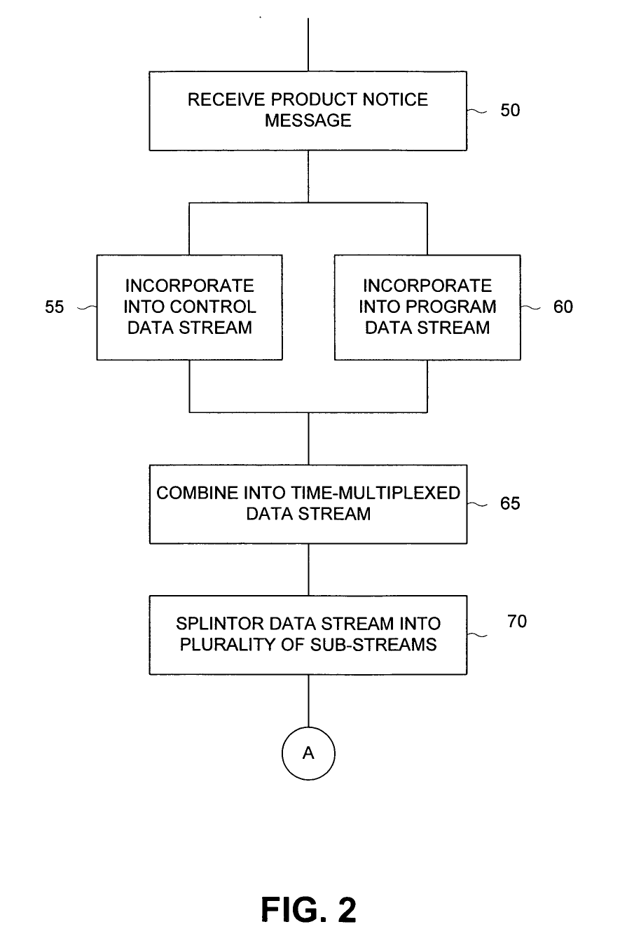

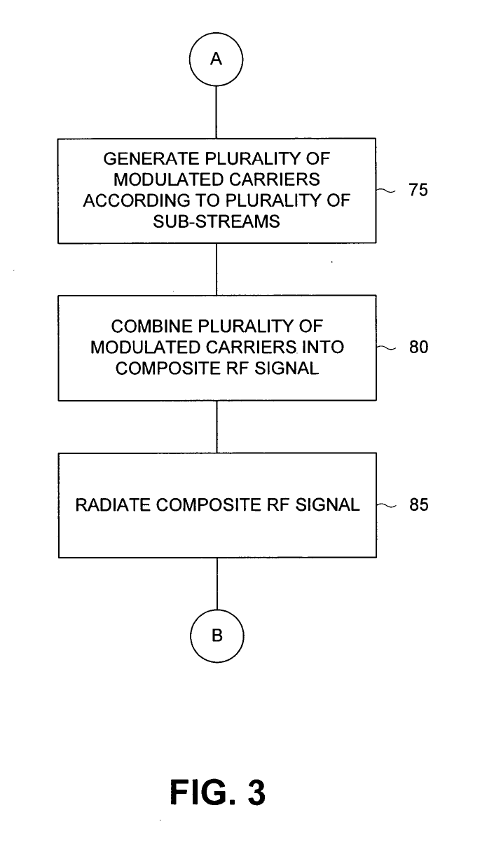

FIGS. 2 and 3 comprise a flow diagram that depicts alternative example methods for conveying a product notice message to a product notice receiver. According to one example variation of the present method, a product notice message is first received (step 50). The product notice message, according to various alternative example methods, is received either at a control station 40 or at a direct broadcast radio station 25. It should be appreciated that the product notice message may be received in any facility and the examples set forth herein are not intended to limit the scope of the claims appended hereto.

According to one example variation of the present method, the product notice message is incorporated into a control datastream (step 55). According to yet another example variation of the present method, the product notice message is incorporated into a program datastream (step 60). It should be appreciated that various forms of digital broadcasting utilize independent datastreams for various purposes. For example, direct broadcast digital radio utilizes a single datastream for an audio program. Direct digital broadcasting also utilizes a control datastream. The control datastream is typically used to convey various types of non-audio program information. For example, the control datastream may be used to convey station identification information, which may then be received by a digital broadcast receiver. This same schema is utilized in direct broadcast digital satellite radio, for example XM Radio and Serius Radio.

It should also be appreciated that a control datastream or a program datastream is combined into a time-multiplex datastream (step 65). According to one illustrative use case, a time-multiplexed datastream includes at least one of one or more control datastreams and one or more program datastreams.

Once at least one of a program data stream and a control data stream is combined into a time-multiplexed datastream, the time-multiplexed datastream is then splintered into a plurality of sub-streams (step 70). Each of these sub-streams is then used to generate a modulated carrier. Accordingly, a plurality of modulated carriers are generated according to the plurality of sub-streams (step 75), wherein a particular carrier is modulated according to a particular corresponding data sub-stream.

The plurality of modulated carriers are then combined into a composite radio frequency (RF) signal (step 80). The composite RF signal is then radiated (step 85). It should be appreciated that, according to one illustrative use case, the radiated composite RF signal is directed to a direct broadcast satellite 30. According to get another illustrative use case, the composite RF signal is directed from a direct broadcast satellite 30 to a product noticed receiver 10. According to get another illustrative use case, the composite RF signal is convey from a direct broadcast radio station 25 to a product noticed receiver 10.

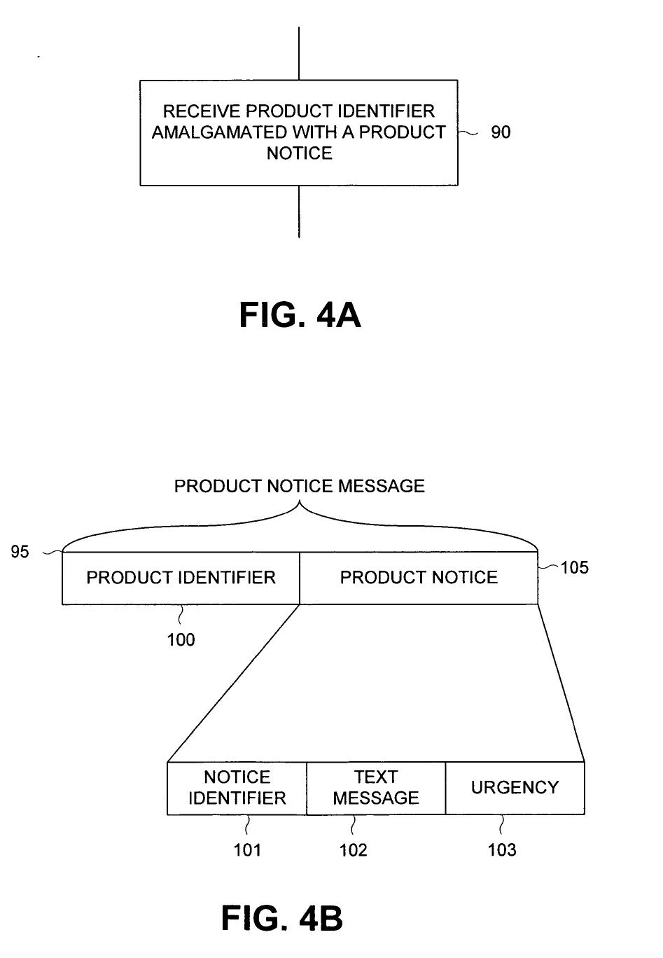

FIG. 4A is a flow diagram that depicts one example method for receiving a product notice message according to a product identifier. As described in the incorporated references, a product notice message typically includes a product notice and a product identifier. Typically, the product identifier, as already described in the incorporated references, includes at least one of a product model number, a product lot code number, a product date code number, a product serial number, a “SKU” number (stock keeping unit), or any other arbitrary product identifier. It should also be appreciated that such a product identifier, as already described in the incorporated references, can be used to refer to a single particular product or to a group of products (for example a group of products manufacturing under a single lot-date code). As such, this variation of the present method provides for receiving a product notice message by receiving a product identifier that is amalgamated with a product notice (step 90). It should also be appreciated that, according to one variation of the present method, a product identifier comprises an assembly number. According to yet another variation of the present method, the assembly number comprises a vehicle identification number (VIN), which is typically used to identifier a particular motor vehicle.

FIG. 4B is a pictorial diagram that illustrates one example embodiment of a product notice message that includes a product identifier. In those illustrative use cases where a product notice receiver is programmed with a product identifier, the product notice receiver will receive a product notice message 95 that includes a product identifier 100 and a product notice 105. It should be appreciated that this example alternative embodiment of a product notice message 95 is set forth here merely to illustrate one illustrative use case and is not intended to limit the scope of the claims appended hereto. Commensurate with the teachings of the first incorporated reference, a product notice includes at least one of a notice identifier 101, a text (or alphanumeric) message 102 and an urgency indicator 103.

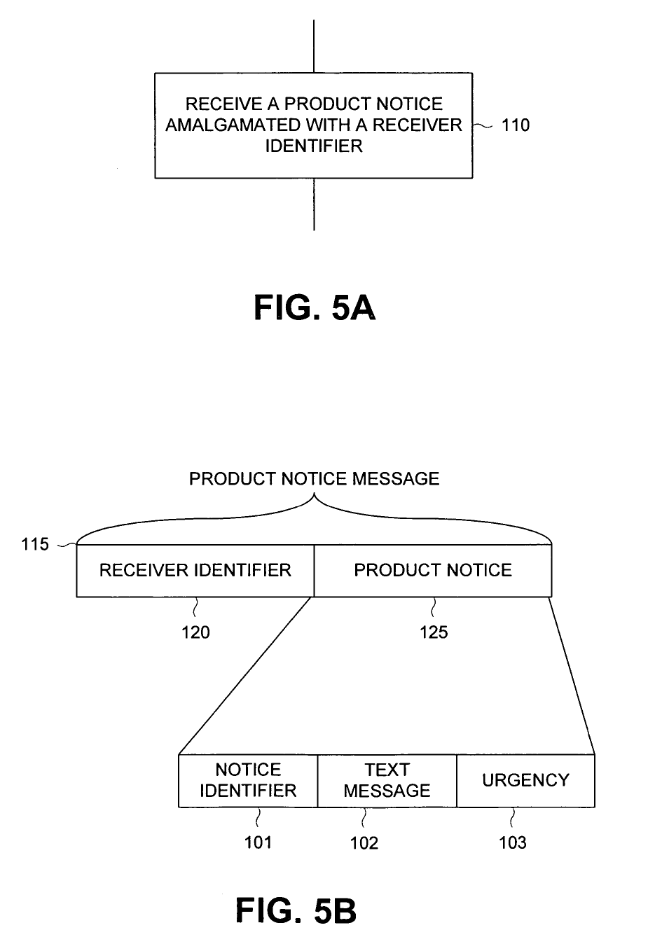

FIG. 5A is a flow diagram that depicts one alternative example method for receiving a product notice message according to a receiver identifier. It should be appreciated that a product notice message, according to this alternative variation of the present method, is received by receiving a product notice that is amalgamated with a receiver identifier. A receiver identifier includes at least one of a digital broadcast radio identification number, an XM Radio receiver identification number and a Serius Radio receiver identification number. As such, a product notice message, according to this example variation of the present method, is received by receiving a product identifier which is amalgamated with a receiver identifier (step 110).

FIG. 5B is a pictorial illustration that depicts one example embodiment of a product notice message that includes a receiver identifier. According to this example alternative embodiment, a product notice message 115 includes a receiver identifier 120 and a product notice 125. Accordingly, when a product noticed receiver receives this alternative example embodiment of a product notice message 115, the product notice message uses the receiver identifier 120 in order to qualify perception of a product notice message for that particular receiver product noticed receiver. It should be appreciated that the product notice receiver will include the receiver identifier value which is matched against the receiver identifier 120 included in this example embodiment of a product notice message 115.

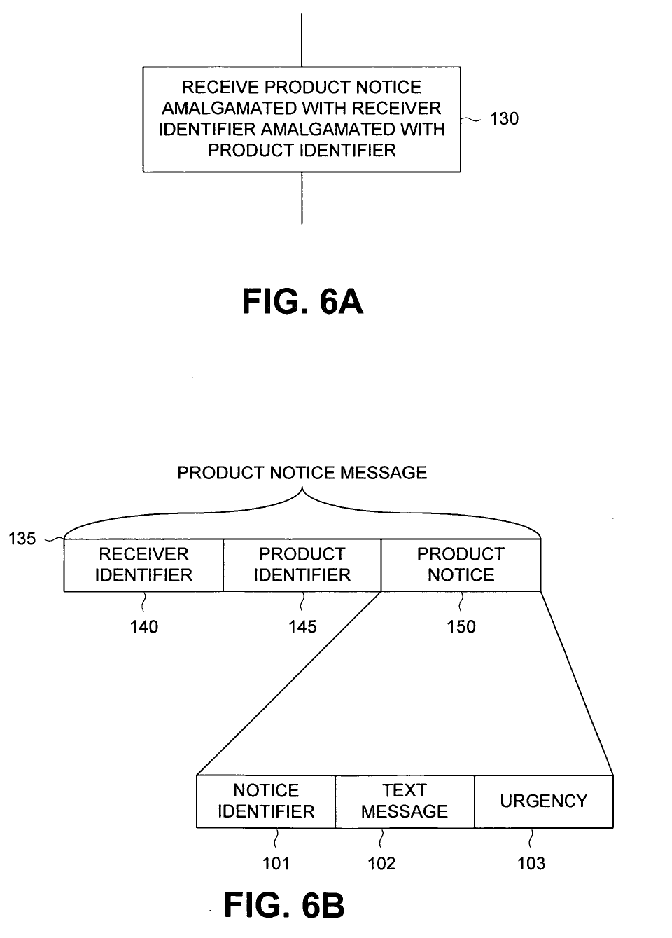

FIG. 6A is a flow diagram that depicts one variation of the present method for receiving a product notice message that includes both the receiver identifier and a product identifier. It should be appreciated that, according to this variation of the present method, a product notice message is received by receiving a product notice which is amalgamated with a receiver identifier and also amalgamated with a product identifier (step 130). It should be appreciated that, according to one alternative example embodiment of a product notice receiver, a product notice receiver will use the receiver identifier in order to qualify reception of a product notice message. It should likewise be appreciated that the product notice receiver may be responsible for receiving product notice messages for a plurality of products (e.g. components in assembly). In this case, the product identifier which is included in the product notice message is used to direct a particular product notice to a particular product included in assembly or to identify a particular product to which a received product notice pertains.

FIG. 6B is a pictorial diagram that depicts one alternative example embodiment of a product notice message that includes both a receiver identifier and product identifier. According to this example alternative embodiment, a product notice message 135 includes a receiver identifier 140, a product identifier 145 and a product notice 150. Accordingly, as described supra, product knows receiver, according to one illustrative use case, will use the receiver identifier 140 in order to qualify to resection of a product notice message. The product notice receiver will then use the product identifier 145 to direct the product notice to 150 to a particular product, for example to a particular component in an assembly. Commensurate with the teachings of the first incorporated reference, a product notice includes at least one of a notice identifier 101, a text (or alphanumeric) message 102 and an urgency indicator 103.

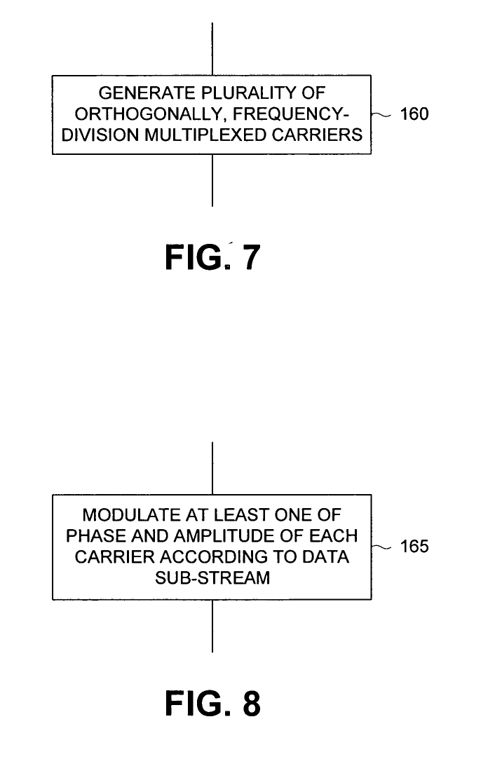

FIG. 7 is a flow diagram that depicts one alternative example method for generating a plurality of carriers. According to this example alternative method, a plurality of carriers is generated by generating a plurality of orthogonally, frequency-division multiplexed carriers (step 160). It should be appreciated that various digital broadcasting schemes employ orthogonal-frequency-division multiplexing for the generation of a plurality of carriers. For example, the AM digital broadcasting standard utilized in the United States relies on orthogonal-frequency-division multiplexed carriers. Direct broadcast satellite systems including, but not limited to Serius Radio and XM Radio, also utilize orthogonal-frequency division multiplexed carriers.

FIG. 8 is a flow diagram that depicts one alternative example method for generating a plurality of carriers. Wherein a particular carrier is modulated according to a data sub-stream, a particular carrier, according to this variation of the present method, is modulated by varying at least one of phase, amplitude and frequency of a carrier according to the data sub-stream (step 165).

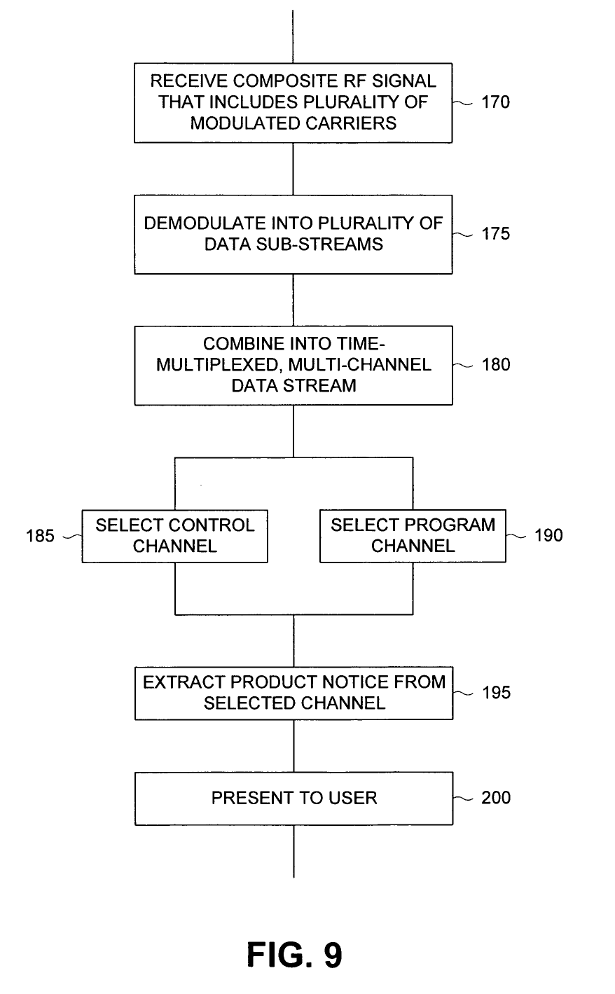

FIG. 9 is a flow diagram that depicts example alternative methods for receiving a product notice message. According to this example alternative method, a product notice message is received by receiving a composite RF signal that includes a plurality of modulated carriers (step 170). Accordingly, the composite RF signal is then demodulated into a plurality of data sub-streams (step 175). The individual data sub-streams are then combined into a time-multiplexed datastream (step 180). According to one alternative variation of the present method, the individual data sub-streams are combined into a time-multiplexed datastream that includes two or more channels. According to one variation of this example method, a control channel is selected from the time multiplexed datastream (step 185). In yet another example variation of the present method, a program channel is selected (step 190) from time-multiplexed datastream. The product notice is then extracted from a selected channel (step 195). It should be appreciated that the selected channel, according to various example methods, includes at least one of a selected to control channel and a selected program channel. Once the product notice is extracted from the selected channel, it is presented to a user (step 200).

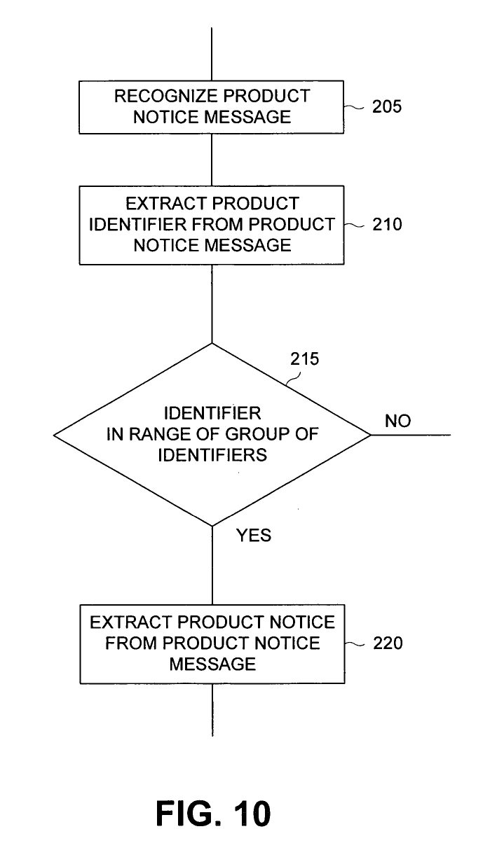

FIG. 10 is a flow diagram that depicts one alternative example method for extracting a product notice message according to a product identifier. According to this example variation of the present method, a product notice message is extracted from a selected channel by first recognizing a product notice message (step 205). Once the product notice message is recognized, a product identifier is extracted from the product notice message. It should be appreciated that, according to various alternative methods, the product identifier is not necessarily extracted, but merely compared against a pre-established value. In the event that the product identifier included in a recognized product notice message is in a particular range or is a member of a particular group or is substantially equivalent to a pre-established value (step 215), the product notice included in the recognized product notice message is extracted. Again, it should be appreciated that a product notice need not necessarily be extracted, it may merely be copied or otherwise obtained from the recognized product notice message so that it can be presented to a user.

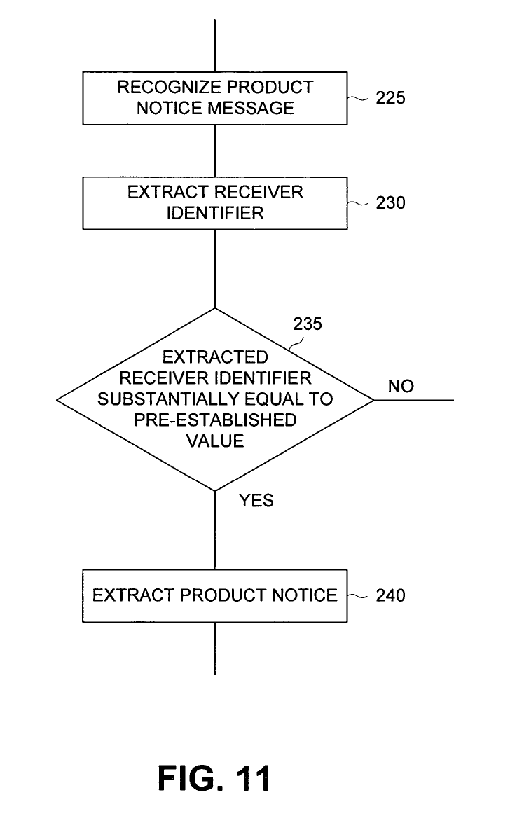

FIG. 11 is a flow diagram that depicts one alternative method for extracting a product notice message according to a receiver identifier. According to this example variation of the present method, a product notice message is extracted from a selected channel by first recognizing a product notice message (step 225). The extracted product notice message of this alternative variation of the present method typically includes a receiver identifier. As such, the receiver identifier is extracted from the product notice message (step 230). The receiver identifier included in a recognized product notice message is compared to a pre-established value (step 235). In the event that the receiver identifier included in the recognized product notice messaged is substantially equal to a pre-established value (step 235), the product notice is obtained from the recognized product notice message so that it can be presented to a user. It should be appreciated that, according to this variation of the present method, extraction of the receiver identifier does not necessarily mean that an actual extraction occurs (i.e. a receiver identifier is separated from the product notice message), but rather the receiver identifier is merely examined, copied or otherwise obtained for use in comparison with a pre-established value.

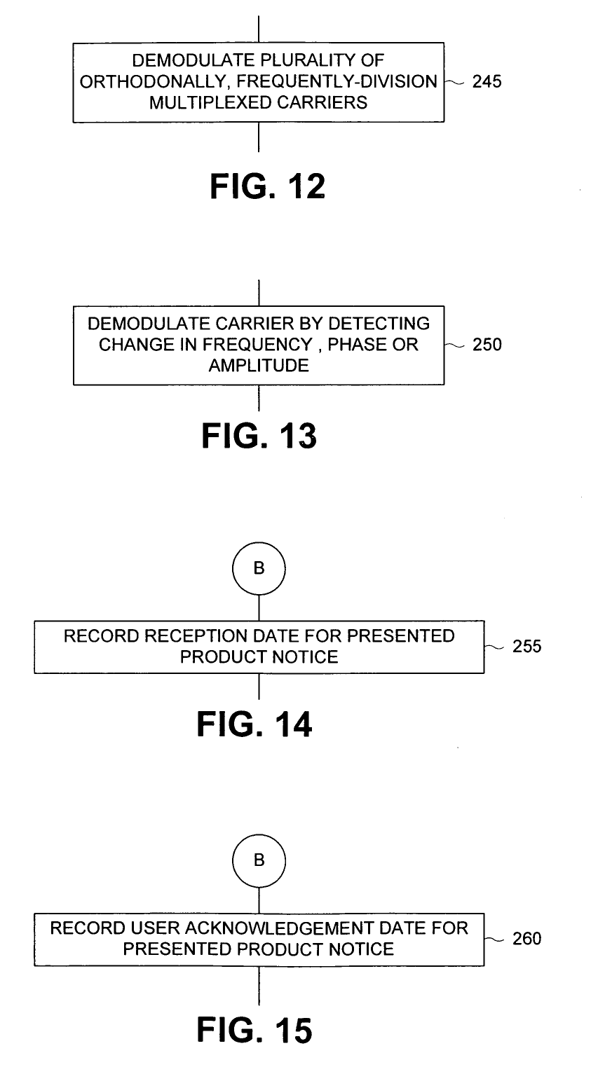

FIG. 12 is a flow diagram that depicts one example alternative method for demodulating a plurality of carriers. According to this example variation of the present method, a plurality of modulated carriers is demodulated by the demodulating a plurality of orthogonally, frequency-division multiplexed carriers (step 245). Accordingly, circuitry in a product notice receiver is typically provided for demodulating each of a plurality of carriers into a corresponding sub-stream of data.

FIG. 13 is a flow diagram that depicts yet another example method for demodulating a plurality of carriers. According to this variation of the present method, demodulation of one or more carriers included in a composite RF signal is accomplished by detecting variations in at least one of frequency, phase and amplitude of a particular carrier and generating a data sub-stream according to the detected variations.

FIG. 14 is a flow diagram that depicts an alternative method for receiving a product notice. According to this example method, once a product notice is presented to a user, the date upon which a product notice message was received is recorded (step 255). In an alternative example method, the date upon which a product notice message is received is stored substantially contemporaneously with the reception of the product notice message. Recording, according to one example variation of the present method, is accomplished by recording the reception date in a substantially permanent manner.

FIG. 15 is a flow diagram that depicts yet another alternative example method for receiving a product notice message. It should be appreciated that, commensurate with the teachings of the first incorporated reference, a product notice message includes at least one of a notice identifier, a text (or alphanumeric message) and an urgency indicator. According to this example variation of the present method, once a product notice message is presented to a user, a user acknowledgment is received from the user. Accordingly, this variation of the present method provides for recording the date upon which a user acknowledged receipt of a product notice that was presented to the user (step 260). Recording, according to one example variation of the present method, is accomplished by recording the user acknowledgement date in a substantially permanent manner. In all instances herein described, the date is either maintained or stored in a format including a system date, a calendar date, and a delta time value from a start epoch, each of which are described fully in the incorporated references.

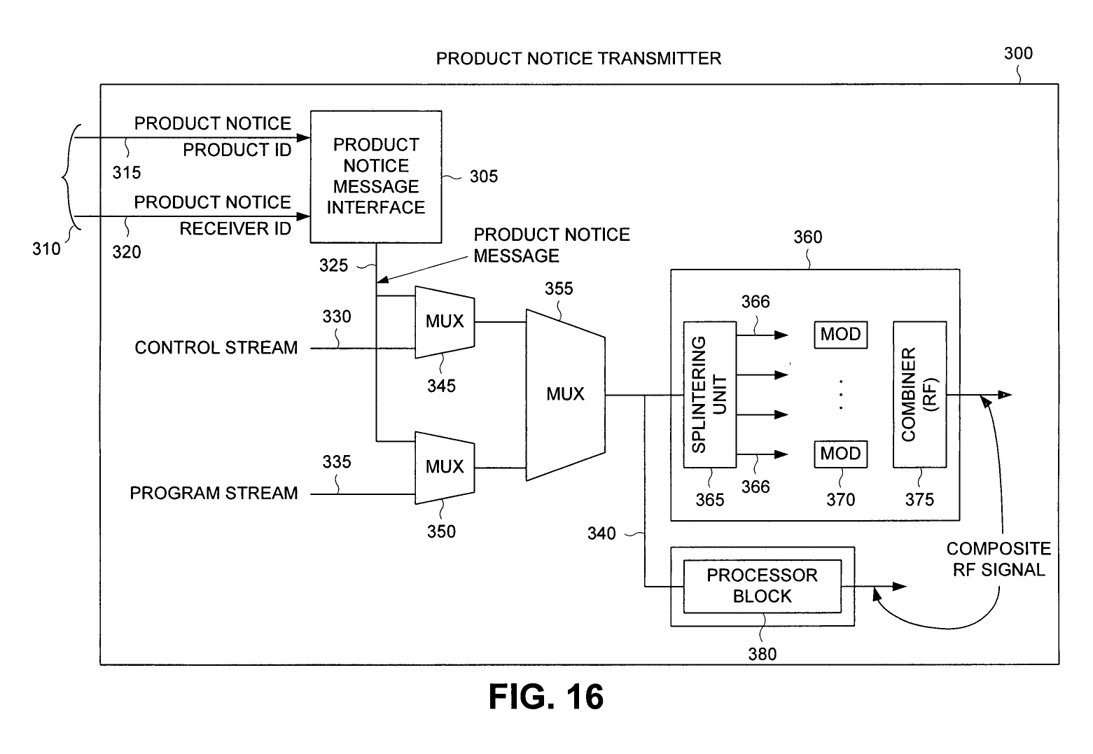

FIG. 16 is a block diagram that depicts several alternative example embodiments of a product notice transmitter. According to one example embodiments, a product notice transmitter comprises a product notice message interface 305. The product notice message interface 305 typically receives a product notice message 310 from an external apparatus. The product notice message interface 305 directs a received product notice message 325 to at least one of a controlled datastream multiplexer 345 and a program stream multiplexer 350. In the case where the product notice message 325 is directed to a control stream multiplexer 345, the control stream multiplexer 345, included in one alternative example embodiments, incorporates a received product notice message 325 into a control datastream 330. In yet another example alternative embodiment that includes a program to datastream multiplexer 350, a received product notice message 325 is incorporated into a program stream 335 by operation of the program stream multiplexer 350. It should be appreciated that, according to one alternative example embodiment, a product notice message is received in the form of a product notice that is amalgamated with a product identifier 315. In yet another alternative example embodiment, a product notice message is received in the form of a product notice that is amalgamated with a receiver identifier 320.

According to one alternative example embodiments, a product notice transmitter 300 further includes a stream multiplexer 355. The stream multiplexer 355 combines at least one of a controlled datastream and a program data stream into a time-multiplexed datastream 340. A multi-carrier modulator is also included in this example embodiment of a product notice transmitter 300. A multi-carrier modulator, according to one alternative example embodiment, comprises a discrete modulator system 360. In yet another alternative example embodiment, a multi-carrier modulator comprises a digital signal processing block 380. It should be appreciated that wide variety of multi-carrier modulator types can be employed and the two examples presented herein are not intended to limit the scope of the claims appended hereto. In nay case, it should further be appreciated that a multi-carrier modulator of one alternative example embodiment generates modulated carriers that are modulated according to at least one of frequency, phase, amplitude and any combination of these. For example, a carrier, according to one alternative embodiment, is modulated as a quadrature amplitude modulated (QAM) signal.

In one alternative example embodiment, a multi-carrier modulator comprises a discrete modulator system 360. A discrete modulator system 360 comprises a splintering unit 365 that splinters a time-multiplexed datastream 345 into a plurality of data substreams 366. A discrete modulator system 360 further includes a plurality of modulators 370, each corresponding to a particular substream output provided by the splintering unit 365. Accordingly, a particular modulator 370 generates a modulated carrier according to a corresponding data substream 366. A plurality of modulated carriers generated by the plurality of modulators 370 is combined into a composite radiofrequency signal by an RF combined 375. It should be appreciated that the combiner 375 is included in this alternative example embodiment of a multi-carrier modulator.

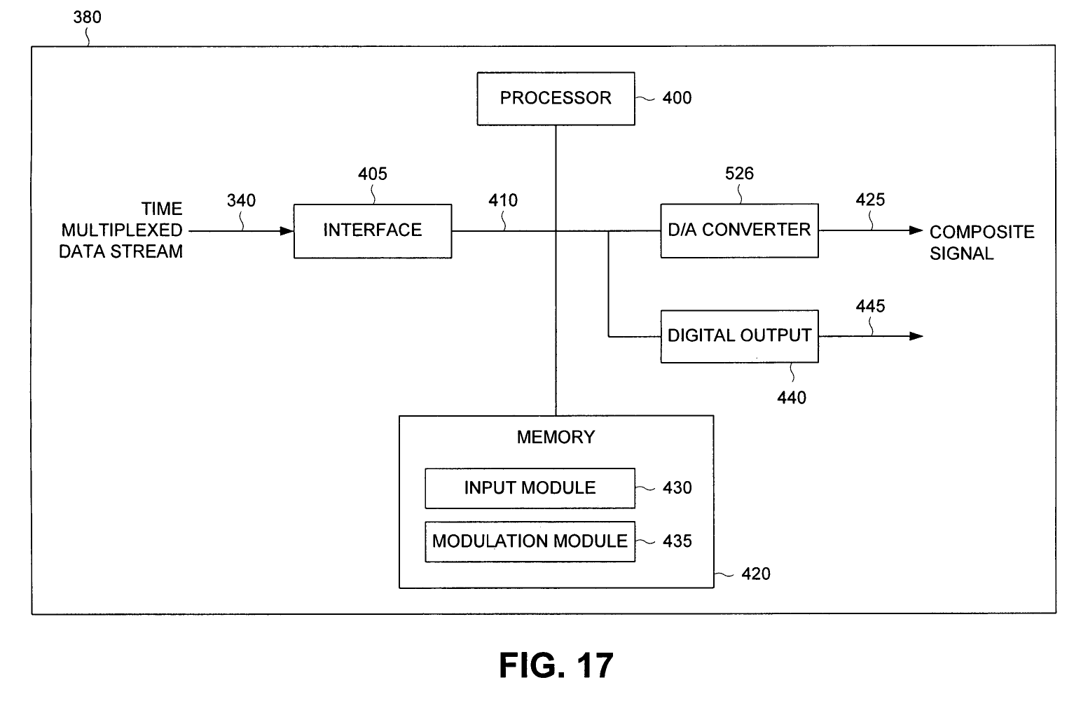

FIG. 17 is a block diagram that depicts several alternative example embodiments of a digital signal processing multi-carrier modulator. According to one alternative example embodiment, a multi-carrier modulator 380 comprises an input interface 405 which is capable of receiving a time-multiplexed datastream 340. Also included in one alternative example embodiment is a processor 400, which is capable of executing an instruction sequence. A memory 420 is also included in this example alternative embodiment. This example alternative embodiment further includes one or more instruction sequence is stored in the memory 420. According to one alternative example embodiment a digital output interface 440 is included. The digital output interface 440 is capable of presenting a digital representation 445 of a multi-carrier signal. According yet another alternative example embodiment, a digital-to-analog converter is included. According to this alternative example embodiment, the digital-to-analog converter is capable of receiving a digital representation of a multi-carrier signal in generating an analog representation thereof. The analog representation of the multi-carriers signal comprises a composite RF signal 415.

Various example embodiments of a product notice transmitter as heretofore described further include various functional modules each of which comprises an instruction sequence that can be executed by the processor 500. An instruction sequence that implements a functional module, according to one alternative embodiment, is stored in the memory 420. The reader is advised that the term “minimally causes the processor” and variants thereof is intended to serve as an open-ended enumeration of functions performed by the processor 400 as it executes a particular functional module (i.e. instruction sequence). As such, an embodiment where a particular functional module causes a processor 400 to perform functions in addition to those defined in the appended claims is to be included in the scope of the claims appended hereto.

The functional modules (and their corresponding instruction sequences) described thus far that enable transmission of a product notice message, according to one alternative embodiment, are imparted onto computer readable medium. Examples of such medium include, but are not limited to, random access memory, read-only memory (ROM), Compact Disk (CD) ROM, Digital Versatile Disk (DVD), floppy disks, hard disk drives and magnetic tape. Yet other examples include, but are not limited to a software download channel wherein an instruction sequence is received by means of a communications channel and then stored in the memory 560. These forms of computer readable medium, which alone or in combination can constitute a stand-alone product, can be used to convert a general-purpose computing device into a product notice transmitter wherein said product notice transmitter is capable of transmitting a product notice message according to the techniques and teachings presented herein. Accordingly, the claims appended hereto are to include such computer readable medium imparted with such instruction sequences that enable execution of the present method and all of the teachings herein described.

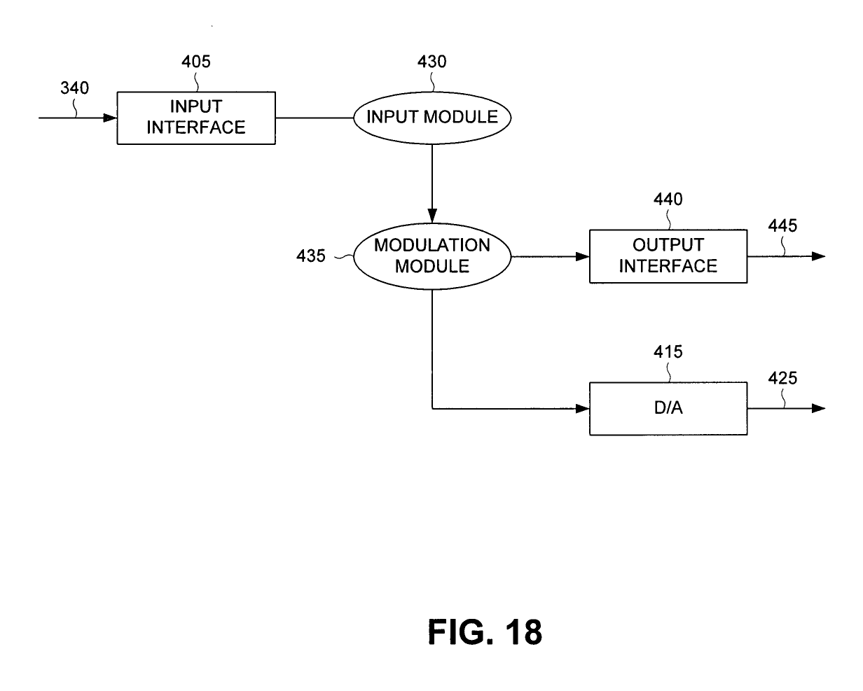

FIG. 18 is a dataflow diagram that it beats the internal operation of several alternative example embodiments of a digital signal processing based multi-carrier modulator. According to one alternative example embodiment, a product notice transmitter 380 further includes an input module 430 that is stored in the memory 420, when executed by the processor 400, the input module 430 minimally causes the processor to receive a time-multiplexed datastream 340 by means of the input interface 405. The input module 430 further minimally causes the processor 400 to convey a time-multiplexed datastream 340 two in modulation module 435. The modulation module 435, which is another functional module included in the memory 420 of this alternative embodiment, minimally causes the processor to create a plurality of modulated carriers according to the time-multiplexed datastream. It should be appreciated that many known techniques can be utilized in the creation of a multi-carriers signal using digital signal processing technology. In one embodiment, the modulation module 435 further minimally causes the processor 400 to direct the digital representation of the multi-carriers signal to a digital output interface 440. Yet another alternative example embodiment, the modulation module 435 further minimally causes the processor 400 to direct a digital representation of the multi-carriers signal to a digital-two-analog converter 415, thereby generating a composite RF signal 425 which can be radiated into free space.

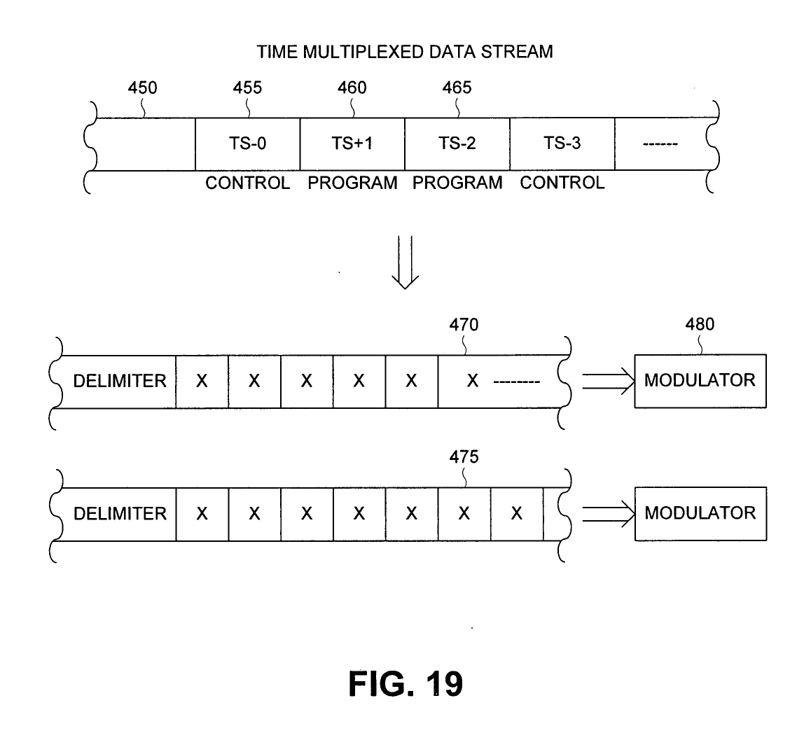

FIG. 19 is a pictorial representation that depicts several alternative example embodiments of the time-multiplexed datastream. According to one alternative example embodiment, a time-multiplexed datastream 450 includes one or more control channels 455. Typically, a particular channel is included in a time slot (e.g. TS-0) within a time-multiplexed datastream. According to yet another alternative example embodiment, a time-multiplexed datastream 450 includes one or more program channels 460. Typically, a particular program channel is carried in a time slot (e.g. TS-1) it should be appreciated that the foregoing description describes various alternative example embodiment of a time-multiplexed datastream and is not intended to limit the scope of the claims appended hereto. For example, one alternative embodiment of a time-multiplexed datastream 450 includes only a single control channel. In yet another alternative example embodiment, a time-multiplexed datastream 450 includes only a single program channel. It is not requisite therefore, that a time-multiplexed datastream include any more than a single channel.

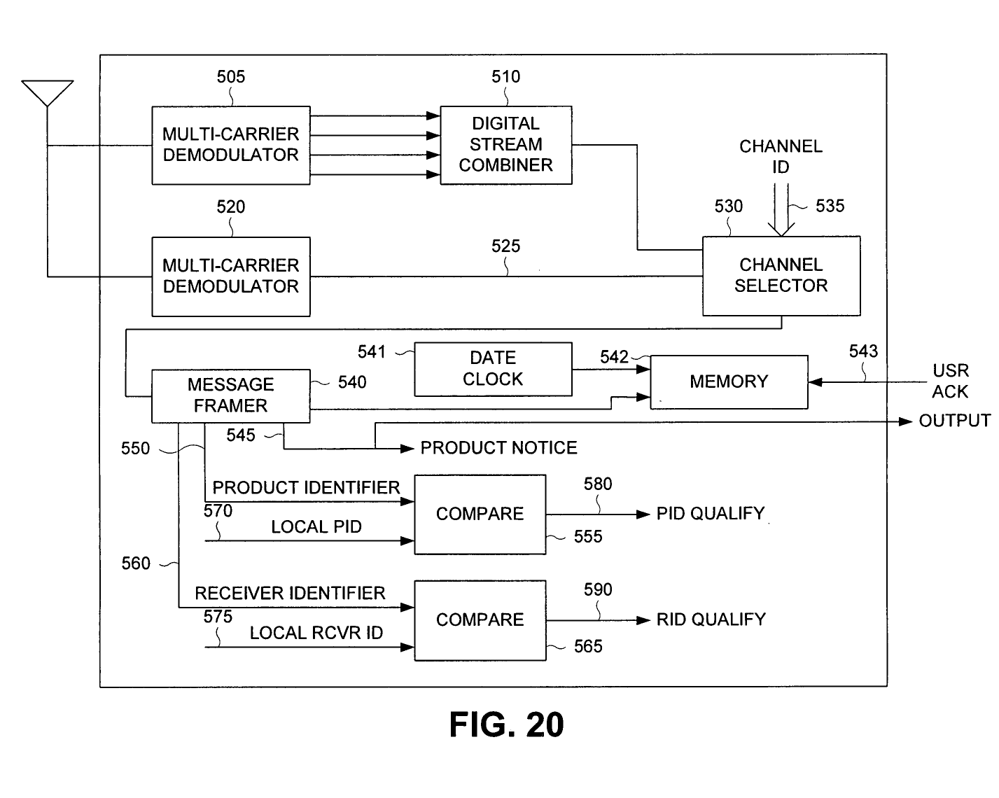

FIG. 20 is a block diagram that depicts several example alternative embodiments of the product notice receiver. According to one example of embodiment, a product notice receiver comprises a multi-carrier demodulator, a channel selector 530 a message framer 540 and a presentation device 545 according to one alternative example embodiment, the multi-carrier demodulator comprises a discrete circuit element. In yet another alternative example embodiment, the multi-carrier demodulator comprises a digital signal processing based demodulator. According to one alternative example embodiment, the multi-carrier demodulator is fashioned to receive an orthogonally-frequency-division multiplexed plurality of modulated carriers. According to yet another alternative example embodiment, a particular demodulator included in a multi-carrier demodulator operates to detect a data substrate by sensing variation in at least one of amplitude, frequency and phase of a modulated carrier included in a multi-carrier composite RF signal.

It should be appreciated that, according to one on example alternative embodiment, the multi-carrier demodulator generates a time-multiplexed datastream (515, 525). the channel selector 530 receives a time-multiplexed datastream and selects a particular channel according to the channel identifier 535. It should be appreciated that the channel identifier 535, according to one alternative example body but, is received from a microprocessor or other controller within a product notice receiver for example, a product notice receiver, according to one alternative example embodiment, is included in a digital broadcast radio (iBiquity) or in a digital broadcast satellite radio (e.g. XM or Serius). typically, a digital broadcast radio or a digital broadcast satellite radio will include a microprocessor, which typically controls other circuitry within the receiver (i.e. the digital broadcast radio or digital broadcast satellite radio). to be appreciated that the channel selector 530 will typically derive a particular channel from a particular time slot, as depicted in FIG. 19.

FIG. 19 further illustrates that a product knows message carried by a particular channel (e.g. a control channel or a program Channel) will itself include a delimiter (472, 476), which is used to identify the start of a product noticed message. A selected channel is provided by the channel selector 530 and directly to the message frame or 540. The message framer is capable of capturing a product notice message from a selected channel. Typically, the message framer 540 will identify the start of a product notice message using a delimiter 472, which is found in a datastream that comprises a selected channel provided by the channel selector 530.

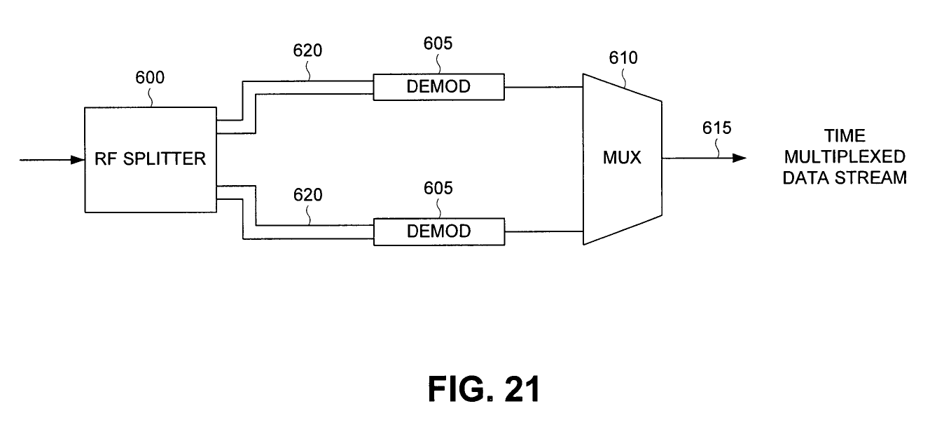

FIG. 21 is a block diagram that depicts one alternative example embodiment of a discrete multi-carrier demodulator. According to this alternative example embodiment, a multi-carrier demodulator comprises a plurality of demodulators 605 which each receive a radio frequency signal. Typically, each demodulator is fed from a radio frequency splitter 600, which is also included one alternative example embodiment of a multi-carrier demodulator. According to yet another alternative example embodiment, each demodulator will include necessary reception circuitry in order to detect a radio frequency signal provided by the radiofrequency splitter 600. Such reception circuitry, according to yet another alternative example embodiment, comprises a mixer, a local oscillator and a filter. Collectively, these example circuit elements enable isolation of a particular carrier included in a multi-carrier signal provided by the RF splitter 600. According to this example alternative embodiment, each of the plurality of demodulators 605 generates a substream of data according to a particular carrier included in a multi-carriers signal (i.e. a composite RF signal). Accordingly, in multiplexed or 610 included in this alternative example embodiment combines the individual substrates into a time-multiplexed datastream 615.

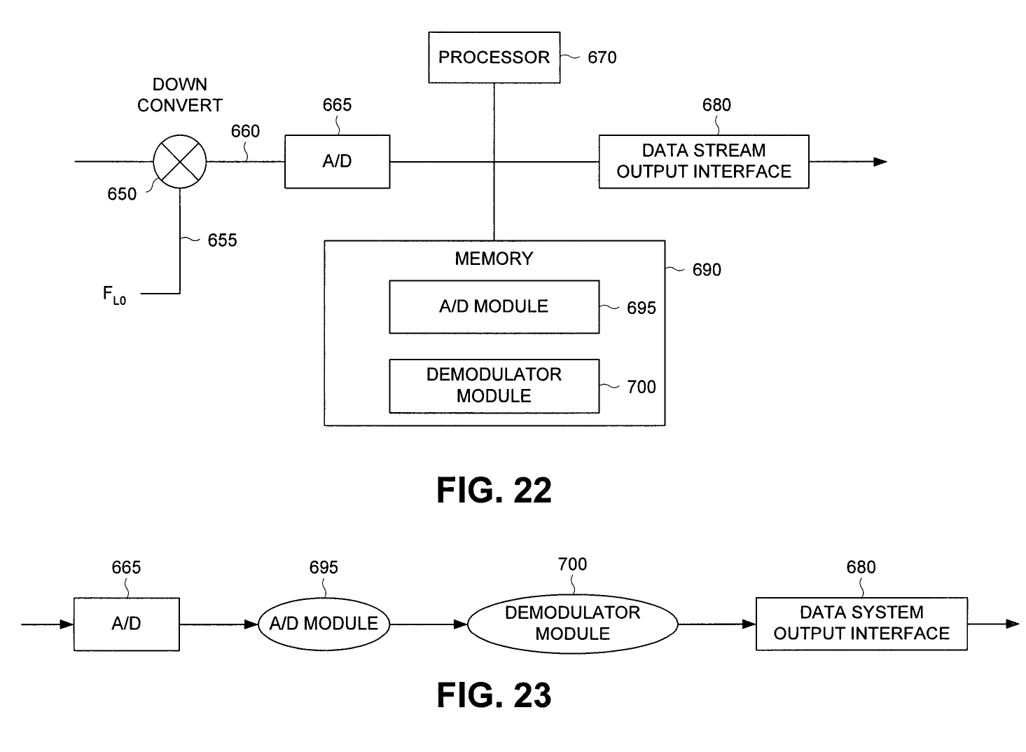

FIG. 22 is a block diagram depicts one alternative example embodiment of a signal processing based multi-carrier demodulator. According to this alternative example embodiment, a multi-carrier demodulator comprises the processor 670, an analog-to-digital converter 665 and a datastream output interface 680. Also included in this alternative example embodiment is a memory 690, which is used to store functional modules (i.e. instruction sequences).

Various example embodiments of a product notice receiver as heretofore described further include various functional modules each of which comprises an instruction sequence that can be executed by the processor 670. An instruction sequence that implements a functional module, according to one alternative embodiment, is stored in the memory 690. The reader is advised that the term “minimally causes the processor” and variants thereof is intended to serve as an open-ended enumeration of functions performed by the processor 670 as it executes a particular functional module (i.e. instruction sequence). As such, an embodiment where a particular functional module causes a processor 670 to perform functions in addition to those defined in the appended claims is to be included in the scope of the claims appended hereto.

The functional modules (and their corresponding instruction sequences) described thus far that enable reception of a product notice message, according to one alternative embodiment, are imparted onto computer readable medium. Examples of such medium include, but are not limited to, random access memory, read-only memory (ROM), Compact Disk (CD) ROM, Digital Versatile Disk (DVD), floppy disks, hard disk drives and magnetic tape. Yet other examples include, but are not limited to a software download channel wherein an instruction sequence is received by means of a communications channel and then stored in the memory 690. These forms of computer readable medium, which alone or in combination can constitute a stand-alone product, can be used to convert a general-purpose computing device into a product notice receiver wherein said product notice transmitter is capable of transmitting a product notice message according to the techniques and teachings presented herein. Accordingly, the claims appended hereto are to include such computer readable medium imparted with such instruction sequences that enable execution of the present method and all of the teachings herein described. As such, an analog-to-digital module 695 and a demodulator module 700 are included in this alternative example embodiment and stored in the memory 690.

FIG. 23 is a dataflow diagram that depicts the internal operation of several example alternative embodiments of a digital signal processing based multi-carrier demodulated. According to one alternative example embodiment, a multi-cure demodulators, as heretofore described, includes an analog-to-digital module 695. When executed by the processor 670, the analog-to-digital module 695 minimally causes the processor 670 to receive a digital sample stream from the analog-to-digital converter 665. The digital sample stream represents a digitized version of an analog signal 660. It should be appreciated that, according to yet another alternative example embodiment, the multi-cure demodulators further includes a mixer 650, which is fed by a local oscillator 655. Typically, the analog signal 660 received from the mixer 650 includes a plurality of modulated carriers.

The processor 670 then executes the demodulator module 700. The demodulator module 700, when executed by the processor 670, minimally causes the processor to detect a plurality of modulated carriers, as represented by the digital sample stream received from the analog-to-digital module 695. The demodulator module 700 further minimally causes the processor to generate a time-multiplexed datastream according to the digital sample stream received from the analog-to-digital converter module 695. It should be appreciated that there are numerous techniques currently known for demodulating a multi-carrier signal. Many of these techniques are applied in broadband communications systems such as digital subscriber line (DSL) modems.

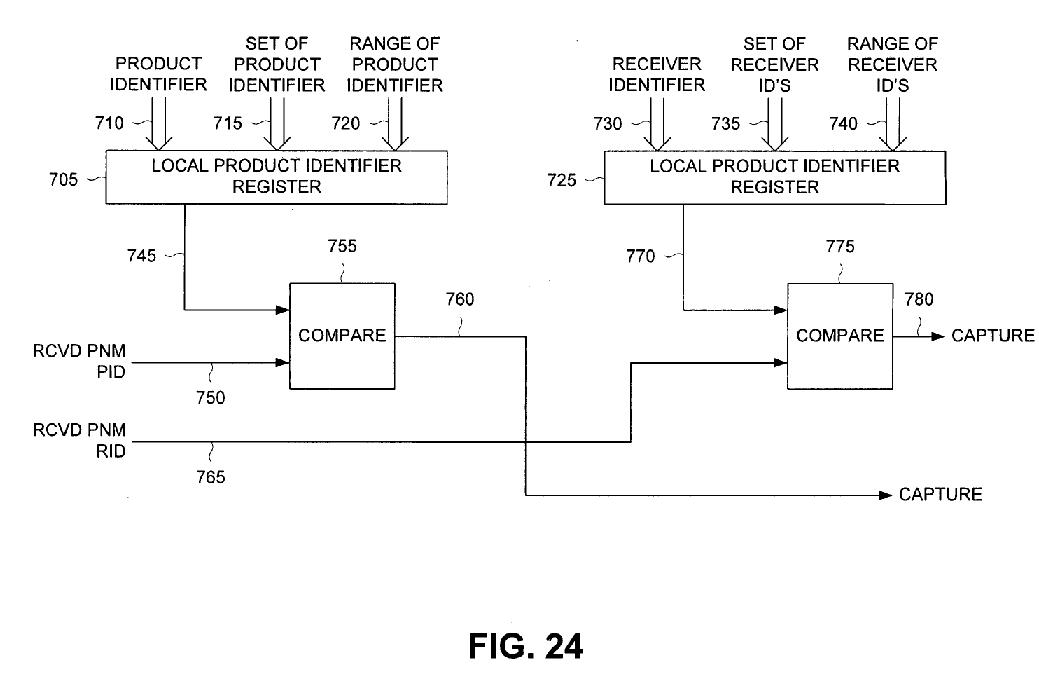

FIG. 24 is a block diagram that depicts one alternative example embodiment of a message framer capable of capturing a product notice message according to a product identifier. In one alternative example embodiment, a message framer 540 includes a local product identifier register 705. According to one alternative example embodiment, the local product identifier register 705 receives a single product identifier 710. This alternative example embodiment, a comparator 755 included in the embodiment receives a single product identifier 745 from the local product identifier register 705. The comparator 755 also receives a product identifier that is included in a received product notice message 750. Based on the comparison, the comparator 755 generates a capture signal 760. Capture signal 760 indicates that a product notice message received in the message framer should be selected for presentation to user.

According to yet another alternative example by, the local product identifier register 705 receives a set of product identifiers 750. According to one illustrative use case, a local product identifier register 705 receives a set of product identifiers 715 in a situation where a product notice receiver is servicing a proudly of products, for example the case where the product notice receiver is integrated into assembly that includes a plurality of components. As such, the comparator 755 compares a received product identifier (i.e. from a received product notice message) 750 and compares the product identifier received a product notice message 750 two each of a plurality of product identifiers 745 received from the local product identifier register 705. Upon a successful comparison, the comparator 755 will generate a capture signal 760, which indicates that a product notice message should be L selected for presentation to a user.

According to yet another alternative example of body but, the local product identifier register 705 receives a range of product identifiers 720. According to one alternative example by, a range of product identifiers 720 is specified according to a beginning value and an into value. The comparator 755 included in this alternative example embodiment compares the range specifier 745 received from the local product identifier register 700 52 a product identifier included in a received product notice message 750. Based upon the comparison, the comparator 755 will generate a capture signal 760 when the received product identifier is within the range specified by the range specifier 745 received from the local product identifier register 705.

FIG. 24 further illustrates that, according to yet another alternative example abide, a message framer includes a local receiver identifier register 725. According to one alternative example of body but, the local receiver identifier register 725 receives a receiver identifier 730, which is typically associated with a single particular digital broadcast receiver (e.g. an XM radio identifier, a Serius radio identifier or an iBiquity digital broadcast receiver). Yet another alternative example abide, the local receiver identifier register 725 stores a set of receiver identifier 735. In yet another alternative example abide, the local receiver identifier register 725 receives a range of receiver identifier 740. A range of receiver identifiers, at least according to one alternative example embodiment, is specified by a beginning value and an ending value.

According to one alternative example embodiment, an included comparator 775 receives a receiver identifier that is included in a received product notice message 765. The comparator 775 compares the received receiver identifier 765 to the content of the local receiver identifier register 725. In one case, this comprises a single receiver identifier received 770 from the local receiver identifier register 725. Based upon a successful comparison, the comparator 775 generates a capture signal 780, which is used to select a product notice message for presentation to a user. In yet another alternative example abide, the comparator 775 receives 770 a set of receiver identifiers 735 from the local receiver identifier register 725 compares these two a receiver identifier 765 included a received product notice message. In the event that the received receiver identifier matches one of the receiver identifiers received 770 received from the local receiver identifier 725, the comparator 775 generates a capture signal 780, which is used to select a product notice message for presentation to a user.

In yet another alternative example body but, the comparator 775 receives 770 a range of receiver identifiers 740. In this embodiment, the comparator 775 generates a capture signal 780 when the received receiver identifier 765 is within a range specifier 770 received from the local receiver identifier register 725. The capture signal 780 generated this manner is used to select a product notice message for presentation to a user.

FIG. 20 further illustrates that, according to yet another alternative example embodiment, a product notice receiver 500 further includes a substantially permanent memory 542. In this alternative example embodiment a data clock 541 is also included in the product notice receiver 500. In this alternative example embodiment, the substantially permanent memory 542 records the date upon which a product knows message is received either according to a product identifier or a receiver identifier according to the techniques and teachings herein prescribed. According to yet another alternative example embodiment, the substantially permanent memory 542 stores a date from the date clock 541 upon receiving a user knowledge but 543, which is indicative that a user acknowledge receipt of a presented product notice message.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

1. (canceled)

2. (canceled)

3. (canceled)

4. (canceled)

5. (canceled)

6. A method for receiving a product recall notice comprising:
receiving in a product a composite radio frequency signal that includes a plurality of modulated carriers;
demodulating each carrier into a plurality of corresponding data sub-stream;
combining the plurality of data sub-streams into a time-multiplexed, multi-channel data stream;
selecting a channel, including at least one of a control channel and a program channel, from the time-multiplexed, multi-channel data stream;
extracting a product recall notice from the selected channel wherein said product recall notice includes a notice identifier that corresponds to a description of the recall stored in a memory that is not included in the product; and
presenting the product notice to a user.

7. The method of claim 6 wherein extracting a product notice comprises:
recognizing a product recall notice message;
extracting a product identifier from the product recall notice message; and
extracting a product recall notice when the product identifier is within a range of a group of product identifiers.

8. The method of claim 6 wherein extracting a product notice comprises:
recognizing a product recall notice message;
extracting a product identifier from the product recall notice message; and
extracting a product recall notice when the product identifier is found in a recognized identifier list.

9. The method of claim 6 wherein extracting a product notice comprises:
recognizing a product recall notice message;
extracting a receiver identifier from the product recall notice message; and
extracting a product recall notice when the receiver identifier is substantially equivalent to a pre-established value.

10. The method of claim 6 wherein demodulating each carrier comprises demodulating a plurality of orthogonally, frequency-division multiplexed carriers into a plurality of corresponding data sub-streams.

11. The method of claim 6 wherein demodulating each carrier comprises demodulating a carrier by detecting a change in at least one of phase, frequency and amplitude.

12. The method of claim 6 further comprising recording a reception date for a presented product recall notice.

13. The method of claim 6 further comprising recording a user acknowledgement date for a presented product recall notice.

14. (canceled)

15. (canceled)

16. (canceled)

17. (canceled)

18. (canceled)

19. (canceled)

20. (canceled)

21. (canceled)

22. A product notice receiver comprising:
multi-carrier demodulator capable of generating a time-multiplexed data stream;
channel selector capable of selecting a channel from a received time-multiplexed data stream;
message framer capable of capturing a product recall notice message from the selected channel; and
presentation device capable of making a captured product notice message available to user.

23. The product notice receiver of claim 22 wherein the multi-carrier demodulator comprises:
plurality of demodulators each capable of generating a data substream; and
multiplexer capable of generating a time-multiplexed data stream according to a plurality of data substream generated by the plurality of demodulators

24. The product notice receiver of claim 22 wherein the multi-carrier demodulator comprises
analog-to-digital converter capable of converting a radio signal into a digital sample stream;
data stream output interface;
processor capable of executing an instruction sequence;
memory capable of storing an instruction sequence;
one or more instruction sequences stored in the memory including:
analog receiver module that, when executed by the processor, minimally causes the processor to receive digital sample stream from the analog-to-digital converter;
demodulation module that, when executed by the processor, minimally causes the processor to generate a time multiplexed data stream according to the digital sample stream received from the analog-to-digital converter and further capable of directing the time-multiplexed data stream to the datastream output interface.

25. The product notice receiver of claim 22 wherein the multi-carrier demodulator comprises an orthogonal-frequency-division multiplexed signal demodulator.

26. The product notice receiver of claim 22 wherein the multi-carrier demodulator comprises a demodulator capable of detecting at least one of a phase variation, a frequency variation and an amplitude variation is a modulated carrier.

27. The product notice receiver of claim 22 wherein the message framer includes:
local product identifier register capable of storing a single product identifier;
comparator capable of generating a capture signal when a received product notice message includes a product identifier that is substantially equivalent to a value stored in the local product identifier register.

28. The product notice receiver of claim 22 wherein the message framer includes:
local product identifier register capable of storing a range of product identifiers;
comparator capable of generating a capture signal when a received product notice message includes a product identifier that is a value with the range of values stored in the local product identifier register.

29. The product notice receiver of claim 22 wherein the message framer includes:
local product identifier register capable of storing a set of product identifiers;
comparator capable of generating a capture signal when a received product notice message includes a product identifier that is substantially equivalent to one of one or more value stored in the local product identifier register.

30. The product notice receiver of claim 22 wherein the message framer includes:
local receiver identifier register capable of storing a one or more receiver identifiers;
comparator capable of generating a capture signal when a received product notice message includes a receiver identifier that is substantially equivalent to one of one or more values stored in the local receiver identifier register.

31. The product notice receiver of claim 22 further comprising a substantially permanent memory capable of storing a date upon which a product recall notice message is received.

32. The product notice receiver of claim 22 further comprising a substantially permanent memory capable of storing a date upon which a product recall notice message is presented to a user.
